(19) United States
(12) Patent Application Publication
(10) Pub. No.: US 2024/0357995 A1
(43) Pub. Date: Oct. 31, 2024

(54) BULK MATERIAL CONTAINER LEVEL INDICATOR

(71) Applicant: Spencer Lee, Henryetta, OK (US)

(72) Inventor: Spencer Lee, Henryetta, OK (US)

(21) Appl. No.: 18/140,087

(22) Filed: Apr. 27, 2023

(51) Int. Cl. A01K 5/02; G01F 23/58

(52) U.S. Cl. CPC A01K 5/0225; G01F 23/58

(57) ABSTRACT

A bulk material container level indicator has a level indicator defining a contact surface engageable with a bulk material in the bulk material container. An indicator rod is connected to and extends downwardly from the contact plate through an opening in a bottom of the bulk material container. The indicator rod is movable in the opening in the bottom of the bulk material container.

### BACKGROUND OF THE INVENTION

Bulk material dispensers of many types are used to dispense bulk material. For example, animal feeders are often used to attract different types of animals for a variety of reasons. Deer feeders are used to attract deer for hunting, photography and simply feeding. In order to be the most useful, the feeder needs to have feed therein at all times. However, constantly checking the feed level from a location proximate the feeder can scare deer and other animals away.

### BRIEF DESCRIPTION OF THE DRAWINGS

FIG. 1 is an elevation view of a bulk material dispenser with a level indicator of the current disclosure.

FIG. 2 is a top plan view of the bulk material dispenser with a level indicator of the current disclosure.

FIG. 3 is a view of a bulk material dispenser with a level indicator of the current disclosure with the bulk material container in cross section.

FIG. 4 is an additional view of a bulk material dispenser with a level indicator of the current disclosure with the bulk material container in cross section.

### SUMMARY OF THE INVENTION

The current disclosure is directed to a bulk material container level indicator. Bulk material dispensers often include containers in which the level of bulk material therein cannot be easily determined from a remote location. The current disclosure is directed to a level indicator that is easily visible from the exterior of the bulk material container. The level indicator is visible from a remote location so that it is not necessary to come near the bulk material dispenser to check the level of bulk material therein. In one embodiment a bulk material dispenser may be an animal feeder, such as a deer feeder. The deer feeder may comprise a bulk material container positioned on legs, and a bulk material level indicator.

The bulk material level indicator may comprise a bulk material level indicator plate that floats on bulk material, such as deer feed, in the bulk material container. A bulk material level indicator rod extends downward from the plate and exits the bulk material container so as to be visible from a location remote from the bulk material dispenser. The bulk material level indicator plate and the bulk material level indicator rod move up and down with the bulk material, so as to give an indication of the level of bulk material in the bulk material container.

### DETAILED DESCRIPTION OF THE EMBODIMENT

In the drawings and description that follow, like parts are typically marked throughout the specification and drawings with the same reference numerals, respectively. In addition, similar reference numerals may refer to similar components in different embodiments disclosed herein. The drawing figures are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is not intended to limit the invention to the embodiments illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described.

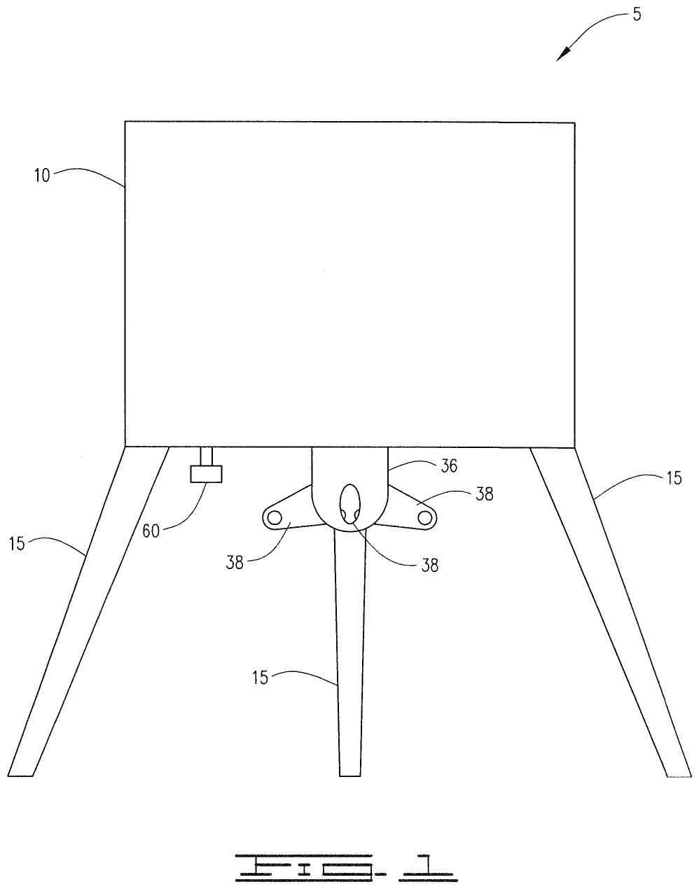

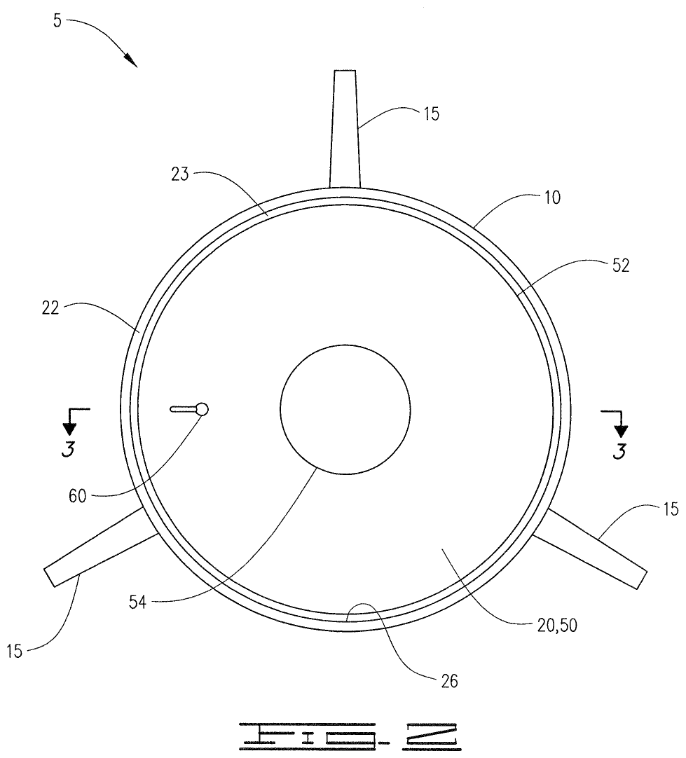

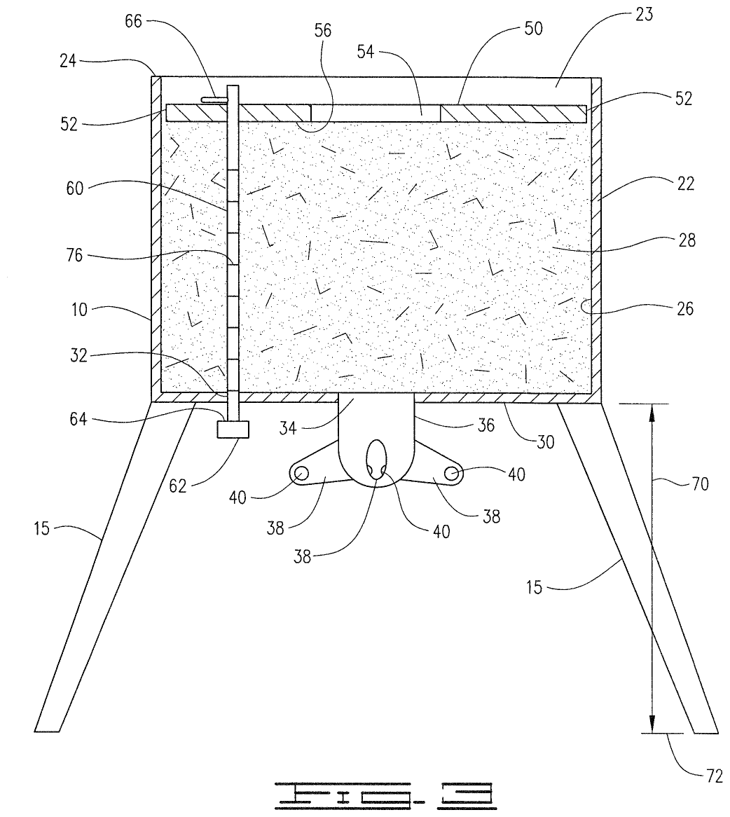

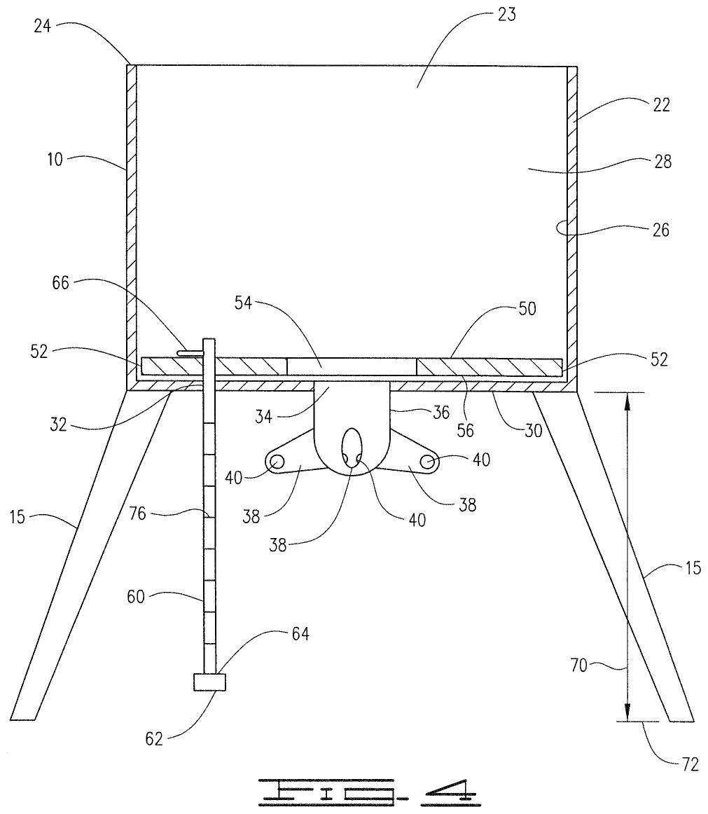

A bulk material dispenser 5 of the current disclosure is shown in FIGS. 1-4. Bulk material dispenser 5 comprises a bulk material container 10 with a plurality of legs 15 connected thereto. A bulk material level indicator 20 of the current disclosure is used in combination with the bulk material container 5 to indicate a level of the bulk material in the bulk material container 10. The bulk material level indicator 20 provides a visual indication on the exterior of the bulk material container 10 of the level of bulk material in the container 10. The bulk material dispenser 5 may be utilized for any bulk material, but is especially useful for animal feeders, such as a deer feeder. Thus, in one embodiment the bulk material dispenser 5 comprises an animal feeder 5. Animal feeders are used by hunters, photographers, and wildlife enthusiasts and others to attract deer and other animals to particular locations. The level indicator 20 allows a person to determine the level of the feed or other bulk material in the container 10 without coming in close proximity with the material dispenser 5. This is advantageous in that constantly coming near the material dispenser 5 can scare animals and prevent them from coming near the material dispenser 5. In one embodiment, the bulk material level indicator 20 of the current disclosure may be colored brightly so that it is easily seen from a distance. The bulk material level indicator 20 may be of a different color than the bulk material container 10 as well.

Bulk material container 10 has a container wall 22 defining an upper opening 23 at an upper end 24 thereof. Container wall 22 has inner surface 26 and defines a container interior 28. In the described embodiment the container wall is generally cylindrical and has a generally cylindrical container interior, but it is understood that the container 10 can be any shape that will hold and dispense bulk material. Container 10 has container bottom 30. Container bottom 30 has an indicator opening 32 in which level indicator 20 is movably received. Container 10 has a material outlet 34. Material outlet 34 is communicated with container interior 28 so that bulk material, such as animal feed will pass from container 10 through material outlet 34. Material outlet 34 may take any form, and may be for example simply a central tube 36 which in one embodiment has a plurality of material outlets 38, which may be feeder tubes 38. Central tube 36 and feeder tubes 38 may have openings 40 therein through which material may be dispensed. In the case of an animal feeder, the openings will be sized and configured to allow an animal, for example a deer, to feed from the opening, but will not allow the feed to simply flow and prematurely empty the container 10.

Level indicator 20 comprises a level indicator plate 50 with outer peripheral edge 52. Outer peripheral edge 52 may be shaped substantially similar to the shape defined by the inner surface 26 of bulk material container 10, and in the described embodiment may be generally circular. Level indicator plate 50 has a central opening 54. Central opening 54 may be any shape, and as described is circular, such that level indicator plate 50 is an annular ring. Level indicator plate 50 has a lower surface 56 that will rest on an upper level of bulk material in container 10, and will move therewith. Level indicator plate 50 will float on the deer feed or other bulk material in bulk material container 10.

Level indicator 20 further comprises a level indicator rod 60 connected to level indicator plate 50. Level indicator rod 60 may be mounted to level indicator plate 50 by any means known in the art. For example, level indicator rod 60 may have a hole with a pin 66 therethrough that will releasably mount the level indicator rod 60 to level indicator plate 50. Pin 66 will prevent level indicator rod 60 from falling through the opening 32 in level indicator plate 50 through which level indicator rod 60 passes. Level indicator rod 60 will extend downwardly from level indicator plate 50 and will pass through any deer feed or other bulk material in container 10. Level indicator rod 60 will exit through an opening in container 10 and will be visible from the exterior of the container 10. In the described embodiment level indicator rod 60 exits through bottom 30 of container 10. In one embodiment level indicator rod 60 has a foot 62 thereon at lower end 64 thereof that is larger in size than the level indicator rod 60 so that it can be easily seen from a distance. Foot 62 may be threaded onto or otherwise releasably connected to level indicator rod 60.

Legs 15 will position container 10 a height 70 above the ground surface 72 so that when the bulk material in container 10 is at a level such that more needs to be added, foot 62 will be slightly above ground level. When foot 62 is proximate bottom 30 of bulk material container 10, bulk material container 10 is at, or near full capacity. In use, the level indicator 20 is visible from a distance, so that there is no need to approach the bulk material dispenser 5 until the level indicator 20 reflects that the bulk material container is at, or near empty. Because the level indicator plate 50 floats on the deer feed or other bulk material, level indicator rod 60 will move downward away from bottom 30 of bulk material container 10, as the deer feed or other bulk material is dispensed. Level indicator rods 60 may have markings 76 thereon to indicate distance measurements, for example inches, so that it can be determined how much the bulk material container has been emptied. In other words, it can be determined exactly how far the level of deer feed or other bulk material in the bulk material container has dropped. Once the level indicator 20 indicates that the bulk material container 10 is at, or near empty, level indicator 20 can be raised upwardly, and deer feed or other bulk material can be poured through opening 32. Level indicator plate 50 will rest and float upon the deer feed or other bulk material, and the bulk material dispenser 5 is once again ready for use.

Bulk material dispenser 5 is particularly useful as a deer feeder as described. Deer feed can be placed in container 10, and the bulk material dispenser 5 positioned in an area where deer may be present. The level indicator 20 will be visible from a remote location, so that it is not necessary to approach the container 10 to check the level of the feed as it goes down as a result of deer feeding. Instead, it will only be necessary to approach the bulk material dispenser 5 to refill the deer feeder container 10 once the level indicator 50 reflects that more feed is needed.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A bulk material dispenser comprising:
a bulk material container comprising a container wall defining a container interior for holding and dispensing bulk material; and
a bulk material container level indicator comprising:
a level indicator plate defining a lower surface resting upon bulk material in the bulk material container; and
an indicator rod connected to and extending downwardly from the level indicator plate through an opening in a bottom of the bulk material container, the indicator rod being movable in the opening in the bottom of the bulk material container.

2. The bulk material dispenser of claim 1, the level indicator plate comprising a flat plate having an outer periphery and a central opening.

3. The bulk material dispenser of claim 2, wherein the outer periphery of the level indicator plate defines a shape substantially similar to a shape of a container interior of the bulk material container.

4. The bulk material dispenser of claim 1, the level indicator plate comprising an annular ring.

5. The bulk material dispenser of claim 1, the level indicator plate configured so that bulk material may pass therethrough to fill the bulk container.

6. The bulk material dispenser of claim 1 comprising an animal feeder.

7. The bulk material dispenser of claim 6 comprising a deer feeder.

8. An animal feeder comprising:
a container with an open upper end and a bottom;
a feed outlet communicated with a container interior of the container;
a level indicator plate sized to fit within the open upper end of the container;
a level indicator rod connected to the level indicator plate and extending downward therefrom through an opening in the container; and
the level indicator plate having a lower surface that rests on and moves with the uppermost level of animal feed in the container, the level indicator rod visible below the container from an exterior of the container.

9. The animal feeder of claim 8, the level indicator plate comprising a flat plate having an outer peripheral edge and a central opening.

10. The animal feeder of claim 8, the level indicator plate comprising an annular ring.

11. The animal feeder of claim 8, the container and level indicator rod having different colored outer surfaces.

12. The animal feeder of claim 8, further comprising a plurality of legs connected to the container, wherein the legs raise the container from a ground surface a sufficient amount to provide clearance for the level indicator rod when the container is at a minimum acceptable fill level.

13. The animal feeder of claim 8, the level indicator rod having a foot at a lower end thereof, the foot being larger than the level indicator rod.

14. A bulk material level indicator for providing a visual indication of a level of bulk material in a bulk material container comprising:
a level indicator plate configured to rest on bulk material in the bulk material container; and
a level indicator rod extending downwardly from the level indicator plate to pass through the bulk material in the bulk material container, the level indicator rod exiting the bulk material container so as to be visible below a bottom of the bulk material container.

15. The bulk material level indicator of claim 14, the level indicator plate defining an opening through which bulk material can be poured.

16. The bulk material level indicator of claim 14, the level indicator plate having an outer peripheral edge shaped substantially similarly to an inner surface of a wall of the bulk material container.

17. The bulk material level indicator of claim 14, an outer peripheral edge of the level indicator plate defining a circle.

18. The bulk material level indicator of claim 14, the level indicator plate comprising an annular ring.

19. The bulk material level indicator of claim 14, the bulk material comprising animal feed.

20. The bulk material level indicator of claim 19, the bulk material comprising deer feed.
